(19) United States
(12) Patent Application Publication
(10) Pub. No.: US 2026/0030314 A1
(43) Pub. Date: Jan. 29, 2026

(54) WEBSITE CONTENT MACHINE LEARNING-BASED ANALYSIS SYSTEM

(71) Applicant: Originality.AI Inc., Collingwood (CA)

(72) Inventors: Jonathan GILLHAM, Collingwood (CA); Conor WATT, Collingwood (CA); Liam MCNALLY, Collingwood (CA)

(21) Appl. No.: 18/919,543

(22) Filed: Oct. 18, 2024

Related U.S. Application Data
(60) Provisional application No. 63/674,472, filed on Jul. 23, 2024.

(51) Int. Cl. G06F 16/958; G06Q 30/0201

(52) U.S. Cl. CPC G06F 16/958; G06Q 30/0206

(57) ABSTRACT

A system to analyze contents from multiple uniform resource locators (URLs) is disclosed. The system comprises a server to acquire URLs from a computing device, each URL corresponding to a unique website. The server renders a minimum processing charge for each URL on a user interface of the computing device. Upon receiving an analysis confirmation input for each URL, the server accesses and generates a data corpus for each webpage. Utilizing a machine learning model, the server computes a billable amount for each URL and renders the computed billable amount on the computing device. Upon receiving an analysis input for each URL, the server executes content analysis to generate and render an analysis outcome for each URL on the computing device.

### CROSS REFERENCE TO RELATED APPLICATION

This application claims the benefit under 35 U.S.C. § 119 (e) of U.S. Provisional Application No. 63/674,472 entitled “WEBSITE CONTENT MACHINE LEARNING-BASED ANALYSIS SYSTEM” filed Jul. 23, 2024, which is incorporated herein by reference.

### TECHNICAL FIELD

The present disclosure generally relates to content analysis of websites. Further, the present disclosure particularly relates to improving cost estimation in the content analysis systems.

### BACKGROUND

Textual content analysis has become increasingly significant with the exponential growth of digital information. The ability to analyze and extract meaningful insights from diverse textual sources (e.g., websites, research paper, white paper etc.) is important for numerous applications, comprising market research, sentiment analysis, and trend monitoring. Conventional systems employed for such textual content purposes utilize manual methods or basic automated tools. Manual methods are labor-intensive, time-consuming, and prone to errors, rendering such methods inefficient for large-scale analysis. Basic automated tools, on the other hand, often lack the capacity required to handle complex and varied textual content, leading to inaccurate or incomplete analysis results.

Various well-known state-of-the-art textual data analysis solutions are existed. For instance, one popular method involves the use of keyword-based search algorithms. Such algorithms scan text data for specific keywords and phrases to determine the relevance and context of the content. However, keyword-based search algorithms are limited by their inability to understand the nuanced meaning of text, leading to inaccuracies and incomplete analysis. Additionally, said algorithms often fail to recognize context, sarcasm, or idiomatic expressions, resulting in significant gaps in the analysis.

Another well-known system utilizes machine learning techniques to analyze textual content. Such techniques involve training models on large datasets to recognize patterns and extract insights. However, machine learning techniques require extensive computational resources and large amounts of training data to achieve acceptable accuracy. Furthermore, the dynamic nature of textual content necessitates continuous retraining of models, adding to the computational burden and increasing costs. The complexity and resource intensity of machine learning techniques often render them impractical for small-scale or budget-constrained applications.

Other state-of-the-art systems also exist for text analysis, including natural language processing (NLP) tools and sentiment analysis engines. NLP tools attempt to understand and interpret human language by analyzing grammatical structure and context. However, NLP tools are limited by the complexity and variability of natural language, leading to potential inaccuracies. Sentiment analysis engines focus on determining the emotional tone of text, but face challenges in accurately interpreting mixed sentiments and context-specific nuances. The inherent limitations of such tools result in incomplete or skewed analysis outcomes.

Conventional systems for text analysis face significant pricing concerns. Such concerns primarily arise from the inability to estimate costs before billing customers. The computational effort required to perform accurate estimations is significant, resulting in inefficiency and customer dissatisfaction. Customers express frustration when billed an uncertain amount without the ability to approve or reject such a charge. The lack of accurate cost estimation tools compounds the problem, creating an urgent need for improved systems to address such pricing concerns.

Manual text analysis methods contribute to the pricing concerns. Such methods demand significant human resources and time, leading to increased costs. The potential for human error further exacerbates the pricing issues, as inaccuracies necessitate additional review and correction efforts, increasing the overall expense. The inability of basic automated tools to accurately analyze complex textual content results in incomplete or inaccurate analysis, further contributing to cost inefficiencies.

The conventional solutions predominantly focus on the analysis of individual webpages. These methodologies restrict their analysis to isolated webpages, thereby limiting the scope of insights of the entire website. Such webpage-centric analysis lacks the contextual understanding necessary for evaluations and disregards the interconnectedness of the entire website. Therefore, insights derived from these conventional approaches may lead to incomplete understanding.

An additional challenge in the domain of text analysis is the detection of plagiarism and artificial intelligence (AI) generated text. Plagiarism detection systems must compare vast amounts of textual content to identify similarities, which can be computationally intensive and prone to false positives or negatives due to the complexity of language. AI-generated text detection presents a unique set of difficulties, as modern AI models can produce highly and contextually appropriate text that can evade traditional detection methods. This necessitates the development of sophisticated technique, which capable of distinguishing between human-authored and AI-generated content, ensuring the integrity and originality of textual data.

In light of the above discussion, there exists an urgent need for solutions that overcome the problems associated with conventional systems and/or techniques for pricing concerns in the text analysis domain.

### SUMMARY

The objective of the present disclosure is to provide a system to efficiently analyze the contents of website using improved machine learning techniques. The system of the present disclosure aims to streamline content analysis, improve accuracy, improve user interaction, and compute a billable amount.

In an aspect, the present disclosure provides a system to analyze the contents, the system comprising a server to acquire one or more uniform resource locators (URLs) from a computing device, each URL associated with a unique website, wherein the unique website is associated with one or more webpages. The server renders a minimum processing charge for each URL on a user interface of the computing device. The server receives an analysis confirmation input for each URL from the computing device. The server accesses each URL based on the received analysis confirmation input to generate a data corpus of each associated unique webpage. The server analyses the generated data corpus of each URL by utilizing a machine learning model to compute a billable amount for each URL and renders the computed billable amount at the computing device. The server receives an analysis input corresponding to each URL from the computing device. The server executes the analysis of the data corpus of each URL based on the received analysis input to generate an analysis outcome (such as presence of AI generated content, etc.) and renders the generated analysis outcome at the computing device.

The server extracts data from each hyperlink embedded in each webpage associated with the website displayed upon access of the URL. The analysis input comprises at least one selected from a selection input to analyze a specific section of the webpage, a specific webpage, a list of sections to be omitted from analysis, an analysis parameter, a priority order, or an acceptance or rejection of the analysis. The analysis parameter comprises a content-specific customization input to customize the analysis criterion. The server transmits a notification to the computing device based on the completion status of the analysis. The data corpus comprises textual data, multimedia data, document files, scripts, forms, dynamic content, structured data, user-generated content, metadata, navigation elements, site maps, Robots.txt instructions, cookies and tracking scripts, SEO elements, and accessibility aspects. The server conducts accessibility and search engine optimization (SEO) compliance analysis, assessing content for compliance with web accessibility standards and SEO best practices. The server implements predictive content impact modelling using machine learning techniques to predict the success of content based on historical data, engagement metrics, and SEO performance. The server enables collaborative workflow integration, allowing multiple users to work with role-based access controls. The server depicts an option at the computing device for continuous or scheduled analysis of the website and provides real-time alerts if the content is suspected of being AI-generated.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates block diagram of a system to analyze the contents, in accordance with various implementations of the present disclosure;

FIG. 2 (FIG. 2A to FIG. 2D) illustrates the graphical user interfaces (GUIs) depicting the process of analyzing contents, in accordance with the embodiments of the present disclosure; and

FIG. 3 illustrates a graphical representation of an analysis outcome, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize which other embodiments for carrying out or practicing the present disclosure are also possible.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

As used herein, the term “system” refers to an arrangement of interconnected components structured to analyze the contents of various webpages of website. Said arrangement comprises a server and a computing device which work in tandem to acquire URLs, render a minimum processing charge, receive analysis confirmation inputs, access URLs, generate a data corpus, analyze the corpus using a machine learning model, compute billable amounts, and render the outcomes. The purpose of the system is to streamline the process of content analysis, providing accurate billing and detailed analysis results.

As used herein, the term “server” refers to a central computing unit to manage the analysis process of URLs acquired from a computing device. The role of the server comprises acquiring URLs, accessing, and rendering URLs, generating a data corpus, analyzing the corpus, computing billable amounts, and transmitting the outcomes back to the computing device. The server functions as the core processing unit, handling data extraction, analysis, and communication tasks. The server efficiently processes large volumes of data, providing timely and accurate analysis results.

As used herein, the term “computing device” refers to a user-operated electronic device which interacts with the server to facilitate the analysis of URLs. The role of the computing device comprises providing URLs to the server, receiving, and confirming analysis inputs, displaying computed billable amounts, and rendering analysis outcomes. The computing device acts as the interface between the user and the server, providing user inputs which are accurately transmitted, and analysis results are clearly displayed. The computing device effectively communicates with the server, providing all analysis tasks which are completed smoothly.

As used herein, the term “uniform resource locator” or “URL” refers to a reference address used to access unique website on the internet. Each URL is associated with a one or more webpages and is provided to the server by the computing device for analysis. The URL serves as the entry point for data extraction and subsequent analysis by the server.

As used herein, the term “data corpus” refers to a collection of data extracted from each webpage of website accessed via URLs. Said data corpus comprises textual content, multimedia files, documents, scripts, forms, dynamic content, structured data, user-generated content, metadata, navigation elements, site maps, Robots.txt instructions, cookies, tracking scripts, SEO elements, and accessibility aspects.

As used herein, the term “machine learning model” refers to a computational model used by the server to analyze the data corpus of each URL. The machine learning model applies a mechanism to assess content and compute billable amounts based on predefined criteria. The machine learning model improves the accuracy and efficiency of the analysis process. The machine learning model processes data swiftly, delivering reliable analysis outcomes.

As used herein, the term “analysis input” refers to user-provided data which specifies the parameters and scope of the URL analysis. Analysis inputs may comprise selections for specific sections of a webpage, a specific webpage, parameters for analysis, priority orders, and acceptance or rejection of the analysis. The analysis input guides the server in conducting the analysis according to user preferences. The analysis inputs are accurately received and implemented, providing customized and accurate analysis results.

As used herein, the term “analysis outcome” refers to the results generated by the server after analyzing the data corpus of each uniform resource locator (URL). The analysis outcome comprises detailed insights into the content, billable amounts, and other relevant metrics. The analysis outcome provides users with valuable information about the analyzed website. The analysis outcome is accurately rendered and displayed on the computing device, offering users clear and actionable insights.

As used herein, the term “content analysis” refers to the process executed by the server to evaluate the textual content associated with each uniform resource locator (URL). The content analysis involves utilization of various techniques to examine the text to derive meaningful insights and compute billable amounts. Furthermore, content analysis encompasses the detection of plagiarism and the determination of whether the text is generated by artificial intelligence (AI) or authored by a human. For instance, when a URL is provided, the system will analyze the textual content of the associated webpage, identifying any sections that may have been copied from other sources (plagiarism detection) and determining whether the writing style and patterns suggest that the text was generated by an AI model or a human author. The content analysis enables examination of the textual data to provide actionable outcomes (e.g., suggestion to re-write content, modify specific section etc.) and insights (e.g., content's originality and authenticity) of the analyze text.

As used herein, the term “hyperlink” refers to an embedded link within a webpage which directs users to additional content or external webpages. The server extracts data from hyperlinks during the analysis process to provide content coverage. Hyperlinks serve as gateways to further information, contributing to the richness of the data corpus.

As used herein, the term “analysis parameter” refers to specific criteria or settings used to customize the analysis of URLs. Analysis parameters may comprise content-specific customization inputs which define the scope and focus of the analysis. Analysis parameters allow users to tailor the analysis to meet specific needs. Analysis parameters are accurately applied, resulting in focused and relevant analysis outcomes.

As used herein, the term “notification” refers to a message transmitted by the server to the computing device, informing users about the completion status of the analysis. Notifications keep users updated on the progress and results of the URL analysis. Notifications are promptly sent to provide users are aware of the analysis status.

As used herein, the term “accessibility” refers to the compliance of webpage content with web accessibility standards, providing content which is usable by individuals with disabilities. The server conducts accessibility analysis to assess and improve the accessibility of webpage content.

As used herein, the term “search engine optimization (SEO)” refers to the practice of optimizing webpage content to improve website visibility and ranking on search engine results pages. The server conducts SEO compliance analysis to assess and improve the SEO performance of webpage content.

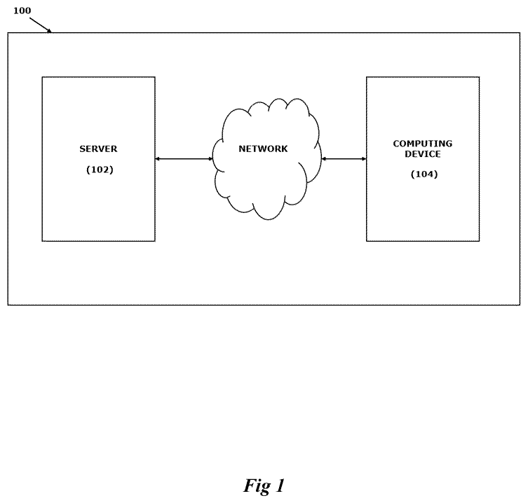

FIG. 1 illustrates a system 100 to analyses the content, in accordance with various implementations of the present disclosure. A server 102 acquires one or more uniform resource locators (URLs) from a computing device 104, wherein each URL is associated individually with a unique website, wherein the unique website is associated with one or more webpages. For an instance website “WWW.EXAMPLE 1.ABDC” comprises various interconnected webpages such as www.example 1.abdc/index.html (i.e., home page introduce website and main features), www.example 1.abdc/about.html (i.e., about us page provides insights about the organization's mission, history, and team), www.example 1.abdc/services.html (i.e., page details the services are offered and description of each service), and www.example 1.abdc/contact.html (i.e., contact page provides essential contact information, a contact form, and customer support details etc.). Together the aforementioned webpages form an integrated and comprehensive representation of the website's content and functionality. server 102 receives URL data transmitted from the computing device 104, providing each URL which corresponds to different website. The server 102 renders, on a user interface of the computing device 104, a minimum processing charges applicable to analyze each URL (regardless of the type and size of the analysis). The server 102 calculates the minimum charge required for processing each URL based on predefined parameters and displays said information on the user interface of the computing device 104. of the rendered processing charge enables users to understand the cost associated with the initiation of analysis of each URL.

In an embodiment, server 102 receives an analysis confirmation input corresponding to each URL from the computing device 104. The server 102 acquires the analysis confirmation input, confirming the request to analyze specific URLs and records said confirmations for processing. Said analysis confirmation input comprises user consent and specific instructions related to the analysis of each URL. The receipt of analysis confirmation inputs by server 102 affirms that only authorized and approved URLs undergo the content analysis process. Upon receiving confirmation, server 102 initiates access to the specified URLs and retrieves the corresponding data from each webpage. Said webpage data is compiled into a data corpus for each unique website, encompassing various elements such as text, multimedia, and metadata.

In an embodiment, server 102 employs the machine learning model to process and analyze the data corpus, extracting valuable insights and calculating the cost associated with the analysis. Said computation of the billable amount is based on the complexity and scope of the content analysis. The utilization of the machine learning model by server 102 improves the efficiency and accuracy of the analysis, providing accurate billing information for each URL.

In an embodiment, the billable amount for the content analysis, as processed by the machine learning model employed by the server 102, can be calculated based on several aspects including but not limited to the complexity of the content, the volume of data, the processing time, resource utilization, the type of analysis performed, accuracy requirements, and the frequency of analysis. The complexity and intricacy of the data within each URL necessitate varying levels of processing, with more complex content requiring advanced analysis. The volume of data directly impacts the computational resources and time needed, with larger datasets incurring higher costs. Processing time is an important factor, as longer durations indicate greater resource consumption. Resource utilization, including CPU and memory usage, also determines the billable amount, with higher resource consumption leading to increased charges. The type of analysis performed (such as sentiment analysis, content categorization, or keyword extraction) varies in complexity and computational demand, influencing the overall cost. Higher accuracy requirements may necessitate extended processing times, resulting in higher costs. Additionally, the frequency of analysis, whether it is repeated or periodic, can affect the overall billing.

In an embodiment, server 102 renders the computed billable amount for each URL at the computing device 104. The server 102 displays the computed cost for analyzing each URL on the user interface of the computing device 104, providing users with a clear understanding of the charges involved. Said rendering of the billable amount provides transparency in the content analysis process, enabling users to review and approve the costs before proceeding.

In an embodiment, server 102 receives an analysis input corresponding to each URL from the computing device 104. The server 102 acquires analysis input specifying the parameters and preferences for the analysis of each URL. Said analysis input comprises details for example sections to be analyzed, priority levels, confirmation, or rejection to analyze data corpus and customization criteria. The receipt of analysis input enables server 102 to tailor the analysis process to meet user requirements, providing the content analysis is conducted in accordance with user-defined specifications.

In an embodiment, server 102 executes analysis of the data corpus of each URL, based on the received analysis input to generate an analysis outcome. The server 102 processes the data corpus in accordance with the user-specified parameters, utilizing the machine learning model to perform a detailed analysis. The analysis outcome comprises insights into the content, highlighting key findings and metrics (for each webpage), which may indicate a presence of artificial intelligence (AI) generated content, plagiarism (with or without source of content).

In an embodiment, the server 102 renders the generated analysis outcome of each URL at the computing device 104. The server 102 displays the results of the content analysis on the user interface of the computing device 104, allowing users to review and interpret the findings. Said rendering of the analysis outcome comprises detailed reports, charts, and visual representations of the analyzed data.

The complete website analysis (to determine text is AI generated or not) can be advantageous as opposed to analyzing individual pages. Complete website analysis enables understanding of content generation patterns, for efficient detection of AI-generated text. The complete website analysis enables consideration of stylistic and linguistic consistencies across different sections/webpages of the website, which might be overlooked when examining isolated pages. For instance, by analyzing the entirety of the website “WWW.EXAMPLE 1.ABDC” various pages such as the home, jobs, about us, and contact us pages can be scrutinized for consistency and patterns indicative of AI-generated content.

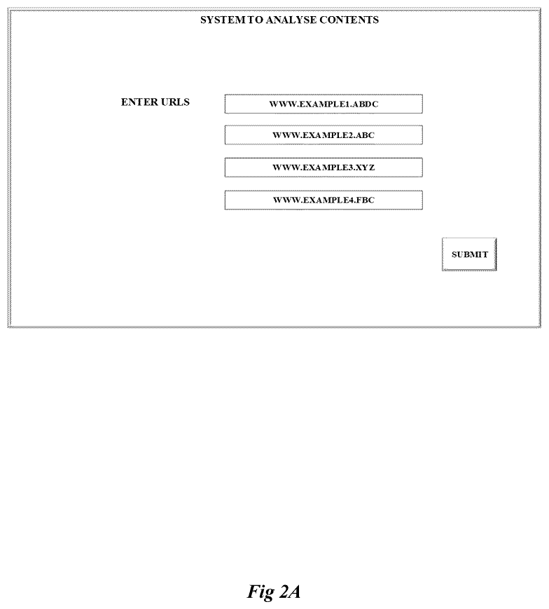

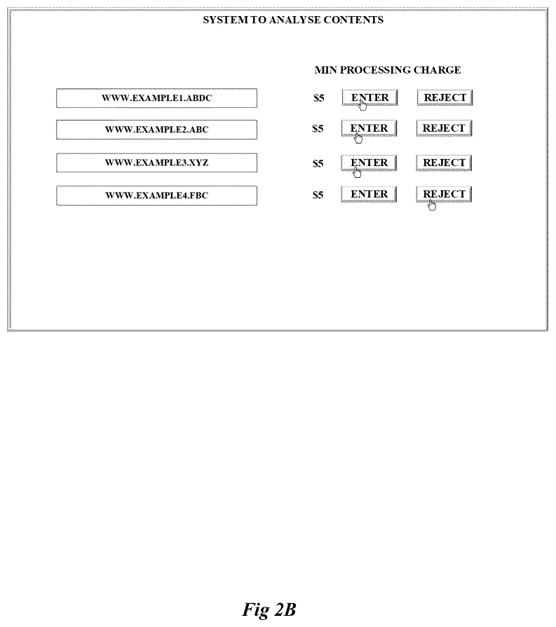

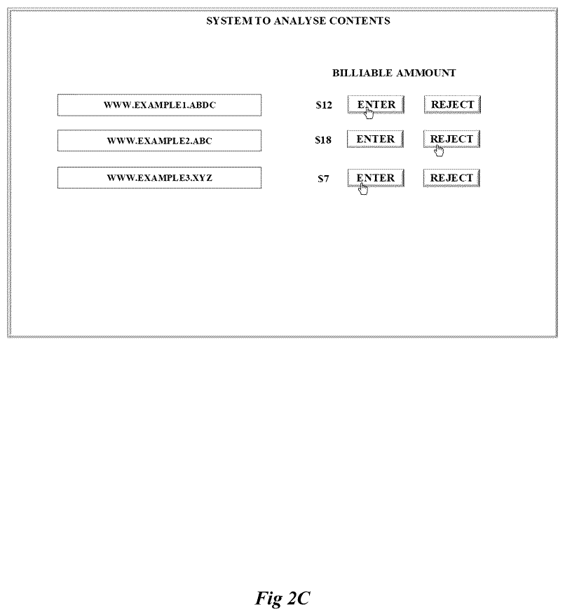

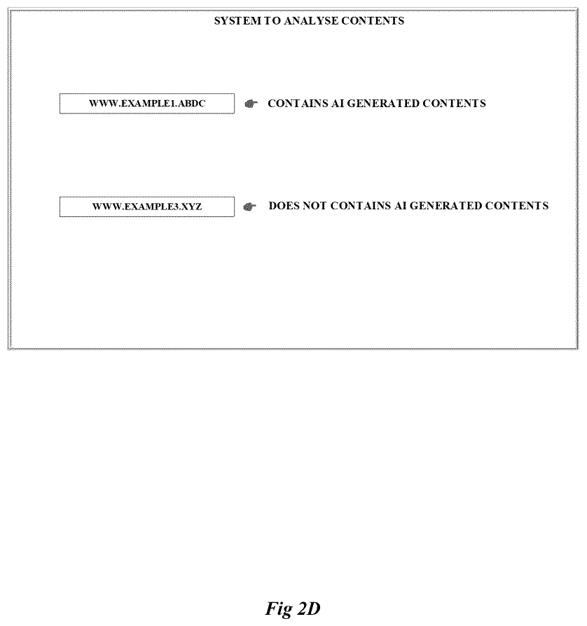

FIG. 2 (FIG. 2A to FIG. 2D) illustrates the graphical user interfaces (GUIs) depicting the process of analyzing contents, in accordance with the embodiments of the present disclosure. Four example URLs are displayed, indicating the capacity of system for multi-input handling. A person ordinarily skilled in the art of developing a GUI may provide an option to enter any number of URLs (either less than or greater than four). FIG. 2A depicts the initial interface where URLs are entered into designated fields. FIG. 2B shows the next stage, where each URL is associated with a minimum processing charge. Users have the option to either accept (enter) or reject the processing of each URL. FIG. 2C moves forward in the process, where the system displays the billable amount for each URL that has been accepted for processing. Again, options to either enter or reject are available. FIG. 2D concludes the sequence, showing the analysis results of the URLs. Each URL is examined to determine the presence or absence of AI-generated contents. The system provides a clear indication of the analysis outcome for each URL. These interfaces collectively outline a systematic approach to content analysis, involving user interaction at various stages, ensuring that the process is both user-driven and transparent. Each stage's feedback loop allows users to make informed decisions regarding the analysis and associated charges. The detailed display of each step aids in maintaining clarity and transparency throughout the content analysis process.

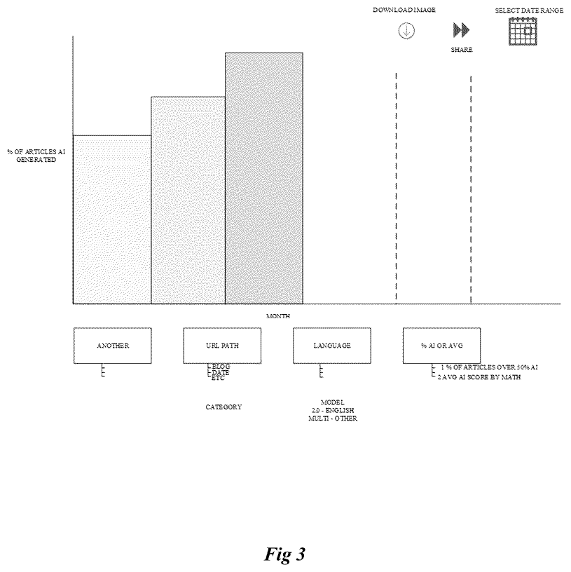

FIG. 3 illustrates a graphical representation of an analysis outcome, in accordance with embodiments of the present disclosure. In an embodiment, once users are notified that the analysis is completed, the results displayed include a graph with several options and a table of data available for download. The graph is a stacked bar graph indicating suspected use of AI. The user has multiple options for filtering the graph data, including selecting by author, category, and URL path. Additional options comprise adjusting the date range, selecting the percentage of articles suspected of being AI-generated (e.g., AI>50%), and choosing the average AI score. User can also select the language or model used for detection, accommodating different AI detection and multilingual requirements.

In an embodiment, server 102 may extract data from each hyperlink embedded in each webpage, wherein the webpage is displayed upon access of the URL. The server 102 initiates the extraction process by parsing the HTML content of the accessed webpage to identify all embedded hyperlinks. Each hyperlink, containing reference addresses to additional resources or webpages, is systematically processed to retrieve the linked data. Said data extraction is integral to compiling a data corpus of the website, capturing the primary content and the related resources linked within the site. Extracting hyperlink data is significant; extracting hyperlink data improves the depth and breadth of the analyzed content, providing analysis which encompasses all relevant aspects of the website. By comprising linked resources, server 102 provides a more thorough and detailed evaluation, which is important for applications requiring extensive data insights. The extracted hyperlink data is then integrated into the main data corpus, enabling the machine learning model to perform an analysis.

In an embodiment, the analysis input may comprise at least one, selected from a selection input to analyze a specific section of the webpage or specific webpage or a list of sections to be omitted from analysis; an analysis parameter; a priority order; an acceptance or a rejection of analysis. The server 102 receives said selection inputs from the computing device 104, allowing users to tailor the analysis process according to specific needs and preferences. The selection input enables users to focus on particular sections of the webpage or exclude irrelevant parts from the analysis, improving the relevance and accuracy of the results. Analysis parameters provide additional customization, specifying detailed criteria for the machine learning model to consider during the analysis. Priority order inputs allow users to prioritize certain aspects of the website content, directing the server 102 to allocate resources and processing power accordingly. Acceptance or rejection inputs give users the final authority to proceed with or abort the analysis based on the preliminary review of the outcomes.

In an embodiment, the analysis parameter may comprise a content-specific customization input to customize an analysis criterion. The server 102 accepts content-specific customization inputs which define particular criteria tailored to the unique characteristics of the webpage being analyzed. Said criteria can comprise specific keywords, topics, formats, or any other relevant content attributes (for example, blogs, articles, news updates, product descriptions, service descriptions, testimonials, case studies, FAQs, how-to guides, tutorials, company history, team bios, mission statements, vision statements, privacy policies, terms of service, contact information, portfolios, white papers, e-books, newsletters, press releases, event announcements, client reviews, resource libraries, etc.) which the user wishes to emphasize or examine closely. By incorporating detailed customization, server 102 can refine the scope and focus of the analysis, making the analysis more pertinent to the user specific objectives. The content-specific customization inputs improve accuracy and relevance of the analysis outcomes. The machine learning model can adapt processing techniques to align with the specified criteria, resulting in a more accurate and insightful evaluation of the webpage content. Said customization capability is particularly beneficial for specialized analyses, for example compliance checks, thematic content reviews, or targeted content quality assessments.

In an embodiment, server 102 may transmit a notification to the computing device 104, based on a completion status of the analysis. The server 102 monitors the progress of the analysis and, upon reaching specific milestones or finalizing the analysis, generates a notification. Said notification comprises relevant information for example the completion status, results summary, and any additional instructions or actions required. The notification is then transmitted to computing device 104, providing the user which is promptly informed of the analysis progress and results.

In an embodiment, the data corpus can comprise a textual data, a multimedia data, the document files, the scripts, the forms, a dynamic content, a structured data, a user-generated content, a metadata, the navigation elements, the site maps, the Robots.txt instructions, the cookies and the tracking scripts, the SEO elements, and the accessibility aspects. The server 102 compiles a data corpus by extracting various types of content from the accessed URLs. Textual data comprises all written content, while multimedia data encompasses images, videos, and audio files. Document files refer to downloadable and viewable documents such as PDFs and Word files. Scripts and forms comprise executable code and user input forms present on the webpage. Dynamic content covers elements which change or update in real-time. Structured data refers to organized data formats, for example databases and tables. User-generated content comprises reviews, comments, and other user inputs. Metadata provides additional information about the content, for example descriptions and tags. Navigation elements facilitate user movement through the webpage, comprising menus and links. Site maps outline the structure of the website. Robots.txt instructions guide search engine crawlers on which parts of the site to index. Cookies and tracking scripts monitor user activity and preferences. SEO elements are optimized for search engine visibility, and accessibility aspects provide the website is usable by individuals with disabilities.

In an embodiment, server 102 may conduct an accessibility and a SEO compliance analysis, wherein the analysis comprises assessing content for compliance with the web accessibility standards and assessing content for the SEO best practices. The server 102 evaluates each webpage content to provide the outcome for website content meets established accessibility standards, for example those outlined by the Web Content Accessibility Guidelines (WCAG). Said WCAG comprises checking for aspects like alternative text for images, keyboard navigability, and screen reader compatibility. Simultaneously, server 102 assesses the content for SEO best practices, which involve optimizing various elements to improve search engine rankings. Said conducting accessibility and SEO compliance analysis comprises evaluating keyword usage, meta tags, link structures, and content quality. Conducting accessibility and SEO compliance analysis is multifaceted which provides website, accessible to a broader audience, including individuals with disabilities, thereby promoting inclusivity and legal compliance. Optimizing for SEO improves the visibility and discoverability of website on search engines, driving more traffic and improving user engagement.

In an embodiment, the server 102 may implement a predictive content impact modeling, wherein said predictive content impact modeling utilizes a machine learning technique to predict the success of content based on historical data, engagement metrics, and SEO performance. The server 102 collects and analyzes historical data from various sources, comprising past content performance, user interactions, and traffic patterns. Engagement metrics, for example page views, time spent on page, social shares, and user feedback are also incorporated into the model. SEO performance data, comprising keyword rankings, backlink profiles, and search engine visibility, are used to refine the predictions. The machine learning model processes said inputs to identify patterns and trends which correlate with successful content. Predictive content impact modeling is the ability to forecast the effectiveness of new or existing content, enabling content creators to make data-driven decisions.

In an embodiment, server 102 may enable collaborative workflow integration, wherein said collaborative workflow integration allows multiple users to work with role-based access controls. The server 102 facilitates collaborative efforts by providing a platform where users can share access to analysis tools, data, and reports while maintaining security through role-based access controls. Said role-based access controls provide each user has appropriate permissions based on their role, for example viewer, editor, or administrator. Collaborative workflow integration supports real-time collaboration, allowing multiple users to work simultaneously on the same project, share insights, and make collective decisions.

In an embodiment, server 102 can depict at the computing device 104 an option for continuous or scheduled analysis of the website and provides real-time alerts if the content is suspected of being AI-generated. The server 102 offers users the flexibility to choose between ongoing, real-time analysis and periodic, scheduled analysis based on specific needs and preferences. Said option is displayed on the user interface of the computing device 104, allowing users to arrange analysis settings accordingly. Additionally, server 102 employs improved detection mechanisms to identify content which may have been generated by AI. If AI content is detected, the server 102 immediately sends real-time alerts to the computing device 104, informing users of the AI-generated content. Continuous analysis provides content is constantly monitored and updated, maintaining content relevance and accuracy.

In an embodiment, system 100 enables centralized and efficient analysis of web content, streamlining the process from data acquisition to result rendering. System 100 facilitates seamless integration and coordination of various functionalities required for data analysis.

In an embodiment, server 102 manages and executes various operations, providing a cohesive workflow and optimal performance. The server 102 provides computational power and storage capacity, enabling the handling of large datasets and complex machine learning tasks. Additionally, server 102 coordinates data transfer and processing between different components, maintaining system integrity and reliability.

In an embodiment, the computing device 104 enables interaction with the system 100. The computing device 104 provides a platform for users to input URLs, receive processing charges, confirm analyses, and view results, making the system 100 accessible and user-friendly.

In an embodiment, acquiring one or more URLs from the computing device 104 allows the system to aggregate data from multiple web sources. Said aggregation enables analysis and comparison across different webpages, providing a broader understanding of web content.

In an embodiment, rendering a minimum processing charge on a user interface informs users about the cost implications of the analysis. Said transparency helps users make informed decisions about which URLs to analyze, promoting cost-effective use of the system 100, establishes a clear cost structure, fostering trust and satisfaction among users.

In an embodiment, receiving an analysis confirmation input corresponding to each URL provides only authorized analyses are conducted. Said confirmation process prevents unauthorized access and processing, safeguarding the system integrity and user data. Analysis confirmation input corresponding to each URL also provides a layer of security, providing users retain control over which URLs are analyzed.

In an embodiment, accessing each URL based on the received analysis confirmation input enables the generation of a data corpus for each unique website. Said targeted access provides relevant data is collected, facilitating accurate and focused analysis. Accessing each URL based on the received analysis confirmation input also allows the system to handle multiple URLs simultaneously, improving efficiency and throughput.

In one embodiment, analyzing the generated data corpus using a machine learning model improves the depth and accuracy of the analysis. The machine learning model can identify patterns, trends, and insights which may not be evident through manual analysis.

In an embodiment, computing a billable amount for each URL based on the analysis provides users are charged fairly according to the computational resources used. Said cost computation reflects the complexity and extent of the analysis, promoting fairness and transparency. Computing a billable amount for each URL also allows users to budget users expenses effectively, aligning costs with analytical needs of user.

In an embodiment, rendering the computed billable amount at the computing device (104) provides users with real-time cost information. Said immediate feedback helps users manage users' budgets and make timely decisions about further analyses.

In an embodiment, receiving an analysis input corresponding to each URL from the computing device 104 allows users to specify their analytical requirements. Said input customization provides the analysis is tailored to the needs of user, improving relevance and usefulness.

In an embodiment, executing analysis of the data corpus based on the received analysis input generates tailored and accurate analysis outcomes. Said targeted analysis aligns with user expectations, providing relevant and actionable insights. Executing analysis of the data corpus also provides the system delivers high-quality results, meeting diverse analytical requirements.

In an embodiment, rendering the generated analysis outcome of each URL at the computing device 104 provides users with immediate access to the results. Said prompt result delivery facilitates timely decision-making and action based on the analysis.

In an embodiment, server 102 extracts data from each hyperlink embedded in each webpage of website displayed upon access of a URL. Such extraction enables data collection by retrieving embedded links, providing no relevant information is missed. The capability to analyze linked content provides a deeper understanding of each webpage, improving the thoroughness and depth of the analysis of website.

In an embodiment, system 100 incorporates an analysis input comprising at least one selection input to analyze a specific section of the webpage or a list of sections which need to be omitted for analysis. Said selective analysis capability allows users to focus on relevant portions of the webpage, improving the efficiency and relevance of the analysis. Such customization provides the system processes only pertinent data, saving computational resources and time. Comprising an analysis parameter enables tailored analysis, aligning with specific user requirements and preferences. The priority order within the analysis input facilitates the management of multiple analyses, providing important analyses which are performed first, optimizing resource allocation. An acceptance or rejection of analysis provides users with control over the analytical process, providing only authorized and desired analyses are conducted, improving security and user satisfaction.

In an embodiment, system 100 comprises an analysis parameter comprising a content-specific customization input to customize an analysis criterion. Said customization input allows for accurate tailoring of the analysis process to suit specific content characteristics, improving the relevance and accuracy of the results. Such customization provides the analysis which can adapt to various types of content, improving content versatility and applicability.

In an embodiment, the server 102 transmits a notification to the computing device 104 based on a completion status of the analysis. Said notification capability informs users in real-time about the progress and completion of the analysis, enhancing user experience and engagement.

In an embodiment, the data corpus comprises textual data, multimedia data, document files, scripts, forms, dynamic content, structured data, user-generated content, metadata, navigation elements, site maps, Robots.txt instructions, cookies and tracking scripts, SEO elements, and accessibility aspects. The inclusion of diverse data types enables analysis, capturing all relevant aspects of each webpage. Wide range of data provides the analysis, which is thorough and multidimensional, providing deeper insights and a more complete understanding of the web content.

In an embodiment, system 100 comprises server 102 which conducts accessibility and SEO compliance analysis. The analysis assesses content for compliance with web accessibility standards, providing webpages which are accessible to all users, including those with disabilities. Said compliance check promotes inclusivity and adherence to legal and regulatory requirements. Additionally, assessing content for SEO best practices improves the visibility and ranking of website in search engine results, driving more traffic and improving user reach.

In one embodiment, server 102 implements predictive content impact modeling. Said predictive content impact modeling utilizes a machine learning technique to predict success of content based on historical data, engagement metrics, and SEO performance. Said predictive modeling enables the system 100 to forecast content effectiveness, assisting users in optimizing content plan and improving engagement outcomes. By historical and performance data, the system provides data-driven insights which inform content creation and marketing decisions, improving overall content impact.

In an embodiment, server 102 enables collaborative workflow integration. Said collaborative workflow integration allows multiple users to work with role-based access controls. Said aspect facilitates team collaboration by providing a structured and secure environment for multiple users to contribute to the analysis process. Role-based access controls provide each user has the appropriate level of access and permissions, improving security and workflow efficiency.

In an embodiment, server 102 depicts an option at the computing device 104 for continuous or scheduled analysis of the website and provides real-time alerts if the content is suspected of being AI-generated. Said continuous or scheduled analysis option allows users to maintain ongoing monitoring of web content, providing updates and changes are promptly analyzed. Real-time alerts for suspected AI-generated content improve content authenticity and quality control, enabling users to identify and address misleading or non-original content.

Further disclosed is a computer program product comprising a non-transitory computer-readable storage medium storing instructions which, when executed by a processor, cause a system to perform a method to analyze the contents. The method comprises acquiring one or more uniform resource locators (URLs) from a computing device by a server, each URL associated with a unique website, wherein the unique website is associated with one or more webpages. The server renders a minimum processing charge for each URL on a user interface of the computing device. The server receives an analysis confirmation input for each URL from the computing device. The server accesses each URL based on the received analysis confirmation input to generate a data corpus of each associated unique webpage. The server analyses the generated data corpus of each URL by utilizing a machine learning model to compute a billable amount for each URL and renders the computed billable amount at the computing device. The method further comprises receiving an analysis input corresponding to each URL from the computing device by the server. The server executes the analysis of the data corpus of each URL based on the received analysis input to generate an analysis outcome (such as presence of AI generated content, etc.) and renders the generated analysis outcome at the computing device.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ or ‘control unit’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, preset targeting accuracy levels, and/or programmatically intelligent software.

What is claimed is:

1. A system to analyze content, the system comprising:
a server configured to:
acquire, one or more uniform resource locators (URLs) from a computing device, wherein each URL is associated, individually, with a unique website, wherein a unique website is associated with one or more webpages;
render, on a user interface of the computing device, a minimum processing charge to analyze each URL;
receive, an analysis confirmation input, corresponding to each URL from the computing device;
access, each URL based on the received analysis confirmation input for each URL, to generate a data corpus of each associated URL;
analyze, the generated data corpus of each URL by utilizing a machine learning model, to compute a billable amount for each URL;
render, the computed billable amount for each URL, at the computing device;
receive, an analysis input corresponding to each URL, from the computing device;
execute, analysis of the data corpus of each URL, based on the received analysis input to generate an analysis outcome; and
render, the generated analysis outcome of each URL at the computing device.

2. The system of claim 1, wherein the server extracts data from each hyperlink embedded in each webpage associated with the website, wherein each webpage is displayed upon access of the URL.

3. The system of claim 1, wherein the analysis input comprises at least one, selected from:
a selection input to analyze a specific section of the webpage or a list of sections needs to be omitted for analysis;
an analysis parameter;
a priority order; and
an acceptance or a rejection of analysis.

4. The system of claim 3, wherein the analysis parameter comprises a content-specific customization input to customize an analysis criterion.

5. The system of claim 1, wherein the server transmits a notification to the computing device, based on a completion status of analysis of the data corpus.

6. The system of claim 1, wherein the data corpus comprises textual data, multimedia data, document files, scripts, forms, dynamic content, structured data, user-generated content, metadata, navigation elements, site maps, Robots.txt instructions, cookies and tracking scripts, search engine optimization (SEO) elements, and accessibility features.

7. The system of claim 1, wherein the server implements a predictive content impact modeling, wherein said predictive content impact modelling utilizes a machine learning technique to predict success of content based on historical data, engagement metrics, and SEO performance.

8. The system of claim 1, wherein the server enables a collaborative workflow integration, wherein said collaborative workflow integration allows multiple users to work with role-based access controls.

9. The system of claim 1, wherein the server depicts at the computing device, an option for the continuous or scheduled analysis of the website and provides real-time alerts, if the content is suspected of being artificial intelligence (AI) generated.

10. A method for analyzing content, the method comprising:
acquiring one or more uniform resource locators (URLs) from a computing device, wherein each URL is associated, individually, with a unique website, wherein the unique website is associated with one or more webpages;
rendering a minimum processing charge to analyze each URL on a user interface of the computing device;
receiving an analysis confirmation input corresponding to each URL from the computing device;
accessing based on the received analysis confirmation input for the respective URLs to generate a data corpus of each associated URL;
analyzing the generated data corpus of each URL by utilizing a machine learning model to compute a billable amount for each URL;
rendering the computed billable amount for each URL at the computing device;
receiving an analysis input corresponding to each URL from the computing device;
executing analysis of the data corpus of each URL based on the received analysis input to generate an analysis outcome; and
rendering the generated analysis outcome of each URL at the computing device.

11. The method of claim 10, wherein a server extracts data from each hyperlink embedded in each webpage associated with the website, wherein each webpage associated with the website is displayed upon access of the URL.

12. The method of claim 10, wherein the analysis input comprises at least one, selected from:
a selection input to analyze a specific section of the webpage or a list of sections needs to be omitted for analysis;
an analysis parameter;
a priority order; and
an acceptance or a rejection of analysis.

13. The method of claim 12, wherein the analysis parameter comprises a content-specific customization input to customize an analysis criterion.

14. The method of claim 10, wherein a server transmits a notification to the computing device, based on a completion status of analysis.

15. The method of claim 10, wherein the data corpus comprises textual data, multimedia data, document files, scripts, forms, dynamic content, structured data, user-generated content, metadata, navigation elements, site maps, Robots.txt instructions, cookies and tracking scripts, search engine optimization (SEO) elements, and accessibility features.

16. The method of claim 10, wherein the server implements a predictive content impact modeling, wherein said predictive content impact modelling utilizes a machine learning technique to predict success of content based on historical data, engagement metrics, and SEO performance.

17. The method of claim 10, wherein a server enables a collaborative workflow integration, wherein said collaborative workflow integration allows multiple users to work with the role-based access controls.

18. The method of claim 10, wherein a server depicts at the computing device, an option for the continuous or scheduled analysis of the website and provides real-time alerts, if the content is suspected of being artificial intelligence (AI) generated.

19. A computer program product comprising a non-transitory computer-readable storage medium storing instructions which, when executed by a processor, cause a system to perform a method for analyzing content, the method comprising:
acquiring one or more uniform resource locators (URLs) from a computing device, wherein each URL is associated, individually, with a unique website, wherein the unique website is associated with one or more webpages;
rendering a minimum processing charge to analyze each URL on a user interface of the computing device;
receiving an analysis confirmation input corresponding to each URL from the computing device;
accessing based on the received analysis confirmation input for the respective URLs to generate a data corpus of each associated URL;
analyzing the generated data corpus of each URL by utilizing a machine learning model to compute a billable amount for each URL;
rendering the computed billable amount for each URL at the computing device;
receiving an analysis input corresponding to each URL from the computing device;
executing analysis of the data corpus of each URL based on the received analysis input to generate an analysis outcome; and
rendering the generated analysis outcome of each URL at the computing device.
